(19) United States
(12) Patent Application Publication
(10) Pub. No.: US 2012/0170964 A1
(43) Pub. Date: Jul. 5, 2012

(54) Surfing Accessory Including Wax Comb and Fin Key

(76) Inventor: Alexander Bogdanoff, Buena Park, CA (US)

(21) Appl. No.: 13/341,782

(22) Filed: Dec. 30, 2011

Related U.S. Application Data
(60) Provisional application No. 61/429,836, filed on Jan. 5, 2011.

(51) Int. Cl. B65D 79/00; B25F 1/00; B65D 85/00

(52) U.S. Cl. 401/52; 7/138

(57) ABSTRACT

A surfing accessory includes a comb residing along a side of an accessory body. The accessory may include a hollow body for holding personal items, or may hold a portion of sun screen or surfboard wax released from the accessory body for use. The comb is shorter than the length of the accessory body and both ends of the accessory body reach to or past the ends of the comb. The accessory further includes a key for tightening a surfboard fin. The key is retractable into the accessory body or folds against the accessory body, and extends for use. A cord, tab, or strap is attached to the accessory body or cap for attaching to a surfboard leash, wet suit, or other feature.

The present application claims the priority of U.S. Provisional Patent Application Ser. No. 61/429,836 filed Jan. 05, 2011, which application is incorporated in its entirety herein by reference.

### BACKGROUND OF THE INVENTION

The present invention relates to surfboard wax and in particular to an applicator including a comb along the side of the applicator for roughing wax applied to the surfboard.

Surfboards and other aquatic boards often require the application of wax to the top surface to prevent a rider from slipping on the top surface. While the wax is easily initially applied to the board before entering the water, during a long event, the wax may lose it's desired properties. It is often not convenient to return to the beach to rough or re-apply wax to return the wax to its desired condition.

U.S. Pat. No. 6,821,041 discloses a surf wax push-up stick with a comb/scraper cap. While the device of the '041 patent allows application and roughing of wax, it is not convenient to carry in the water because the comb/scraper extends from the cap and may be damaged or may cut the rider.

Further, severe sun burns and even skin cancer is a threat to many surfers. Unfortunately, even “very water proof” sun screens only provide protection for about 80 minutes, and such 80 minutes only is achieved if the sun screen is applied fifteen minutes before entering the water, which most surfers don't do. Most surfers exceed 80 minutes while surfing. There is a need for a convenient way to carry sun screen when surfing.

### BRIEF SUMMARY OF THE INVENTION

The present invention addresses the above and other needs by providing a surfing accessory which includes a comb residing along a side of an accessory body. The accessory may include a hollow body for holding personal items, or may hold a portion of sun screen or surfboard wax released from the accessory body for use. The comb is shorter than the length of the accessory body and both ends of the accessory body reach to or past the ends of the comb. The accessory further includes a key for tightening a surfboard fin. The key is retractable into the accessory body or folds against the accessory body, and extends for use. A cord, tab, or strap is attached to the accessory body or cap for attaching to a surfboard leash, wet suit, or other feature.

In accordance with one aspect of the invention, there is provided a surfing accessory including a portion of sun screen in an accessory body. The portion of sun screen slides from the accessory body to expose the sun screen for use. A wax comb attached longitudinally along an outer surface of the accessory body extending along the length dimension of the body. The accessory body is preferably cylindrical but may be square, rectangular, or oval, and the comb extends parallel with the length of the accessory body.

In accordance with another aspect of the invention, there is provided a surfing accessory including a portion of surfboard wax in an accessory body. The portion of surfboard wax slides from the accessory body to expose the surfboard wax for use. A wax comb attached longitudinally along an outer surface of the accessory body extending along the length dimension of the body. The accessory body is preferably cylindrical but may be square, rectangular, or oval, and the comb extends parallel with the length of the accessory body.

In accordance with yet another aspect of the invention, there is provided a surfing accessory including a key for tightening a surfboard fin, the key is retractable into the accessory body and extendable for use, or folds away from the accessory body. The surfing accessory combining the key and accessory body provides a synergistic result in that the accessory body both provides a container for material and provides a convenient handle for the key.

In accordance with still another aspect of the invention, there is provided a wax comb attached to the side of the surfing accessory body. The wax comb is shorter than the length of the accessory body and both ends of the accessory body reach to or past the ends of the comb to prevent snagging the comb on clothing or the like, or breaking the comb.

In accordance with another aspect of the invention, there is provided a surfing accessory including a tab or cord or strap attached to a cap of the accessory body for attachment to a surfboard leash, or a band for attachment to clothing, the leash, or other convenient features. The surfing accessory may be easily detached from the cap for use.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1A is a side view of a first embodiment of a surfing accessory according to the present invention.

FIG. 1B is a second side view of the first embodiment of the surfing accessory according to the present invention.

FIG. 1C is an end view of the first embodiment of the surfing accessory according to the present invention.

FIG. 2A is a side view of the first embodiment of the surfing accessory according to the present invention with an applicator cap removed.

FIG. 2B is an end view of the first embodiment of the surfing accessory according to the present invention with the applicator cap removed.

FIG. 3 is a side view of the first embodiment of the surfing accessory according to the present invention with the applicator cap removed and a fin tightening key extended for use.

FIG. 4A is a side view of a second embodiment of a surfing accessory according to the present invention.

FIG. 4B is a second side view of the second embodiment of the surfing accessory according to the present invention.

FIG. 4C is a third side view of the second embodiment of the surfing accessory according to the present invention.

FIG. 4D is an end view of the second embodiment of the surfing accessory according to the present invention.

FIG. 5 is a side view of the second embodiment of the surfing accessory according to the present invention with an applicator cap removed.

FIG. 6 is a side view of the second embodiment of the surfing accessory according to the present invention with the applicator cap removed and a fin tightening key folded for use.

FIG. 7 is a side view of the second embodiment of the surfing accessory with a strap according to the present invention with the applicator cap removed.

FIG. 8A shows a first side view of a surfing accessory with a key retainer according to the present invention.

FIG. 8B shows a second side view of the surfing accessory with the key retainer according to the present invention.

FIG. 9 shows a cross-sectional side view of a surfing accessory with a telescoping key according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

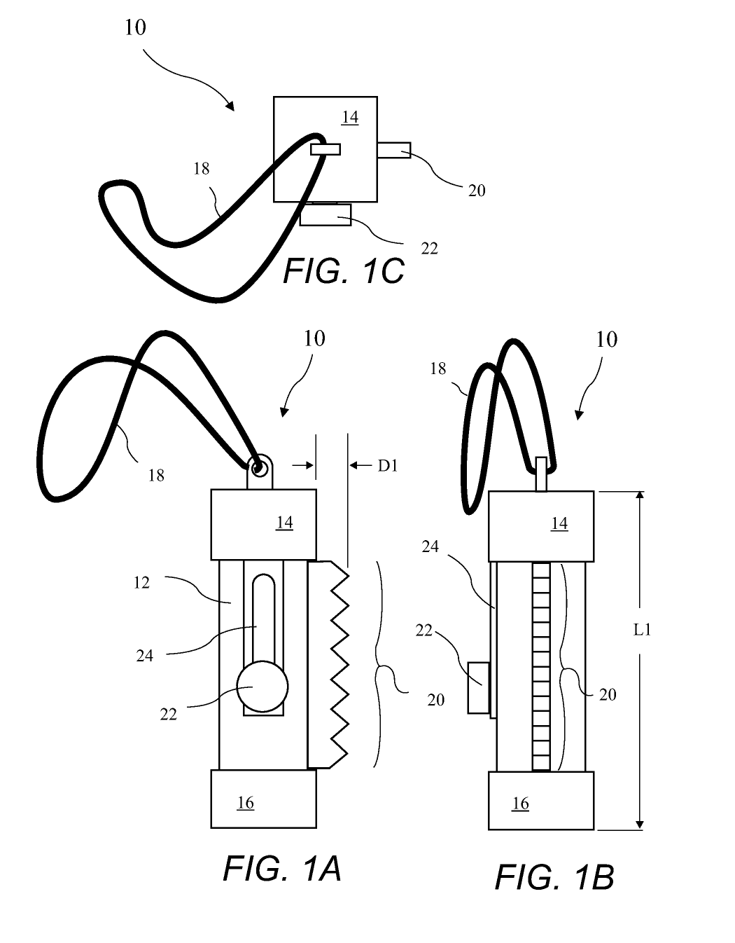

A side view of a first embodiment of a surfing accessory 10 according to the present invention is shown in FIG. 1A, a second side view of the surfing accessory 10 is shown in FIG. 1B, and an end view of the surfing accessory 10 is shown in FIG. 1C. The surfing accessory 10 includes an accessory body 12, a removable cap 14, a knob 16 opposite the cap 12, and a comb 20 residing on a side of the accessory body 12 parallel with a length L1 of the accessory body 12 and reaching between the cap 12 and knob 14. The comb 20 reaches a distance D1 beyond the cap 14. The distance D1 is preferably not more than 1/4 inches. The accessory body 12 may be square, cylindrical, oval, elliptical, or the like.

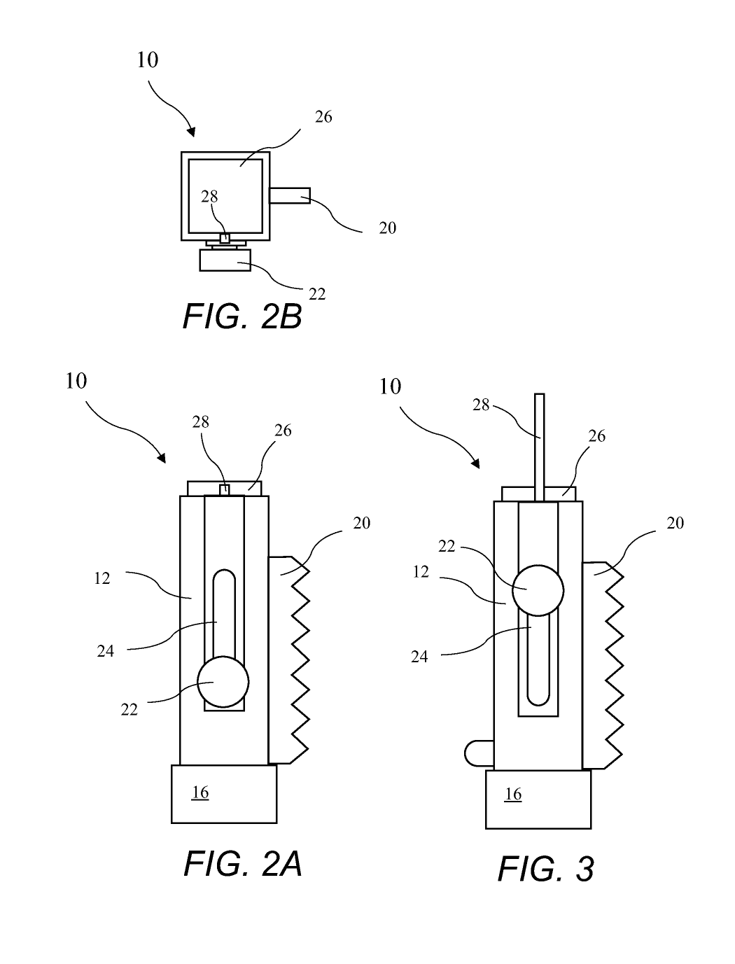

The surfing accessory 10 may contain a portion of material 26 which may be, for example, surfboard wax or sun screen, and is extendable for use (see FIG. 2A). The knob 16 may be part of a known screw mechanism to push the material 26 out of the accessory body 12, or may be removed to allow a user to push the material 26 out of the accessory body. Other means may be utilized to extend the material 26 from the accessory body and any surfing accessory having a comb attached to the side of accessory body is intended to come within the scope of the present invention.

A cord 18 is attached to the surfing accessory 10 and may be attached to a surfboard leash, swimming trunks, shorts, wet suit, or to any suitable attachment point to prevent loss of the surfing accessory 10. The cord 18 is preferably attached to the cap 14.

A side view of the surfing accessory 10 according to the present invention with the cap 14 removed is shown in FIG. 2A, a top view of the surfing accessory 10 with the cap 14 removed is shown in FIG. 2B, and an end view of the surfing accessory 10 with the cap 12 removed and a fin tightening key 28 according to the present invention extended for use is shown in FIG. 3. The key 28 slidably resides on one side of the accessory body 12. A key knob 22 reaches through a slot 24 to engage the key 28 and sliding the key knob 22 extends and retracts the key 28. The key 28 advantageously allows tightening of the surfboard fin without leaving the water.

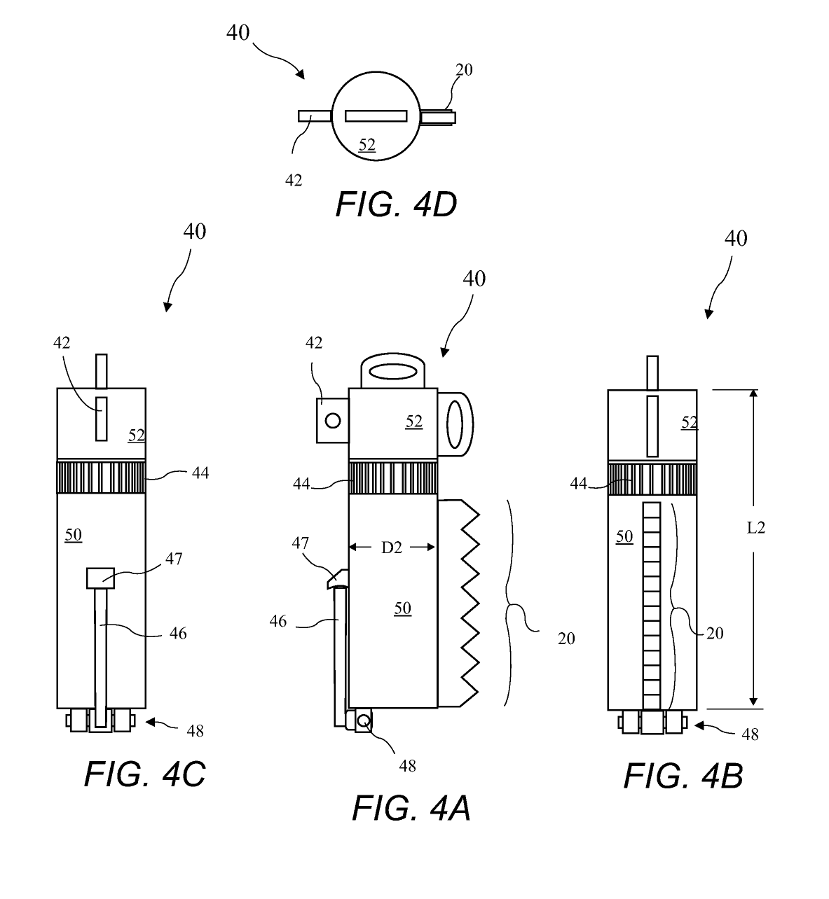

A side view of a second embodiment of a surfing accessory 40 according to the present invention is shown in FIG. 4A, a second side view of the surfing accessory 40 is shown in FIG. 4B, a third side view of the surfing accessory 40 is shown in FIG. 4C, and an end view of the surfing accessory 40 is shown in FIG. 4C. The surfing accessory 40 includes a folding key 46 for tightening the surf board fin. A seat 47 resides on the outside of the accessory body 50 to hold the key 46 in a folded (or stored) position. A tab 42 extends from the cap 52 allowing attachment to a screw which is commonly part of a swivel attachment joint of a surfboard leash. The cap 52 is preferably a press or interference fit to the accessory body 50, but may snap in place, screw in place, or be otherwise detachably attachable to the accessory body 50. The accessory body 50 has a diameter D2 which may vary but is preferably about ¾ inches and a length L2 which may vary but is preferably about 2 and ⅞ inches.

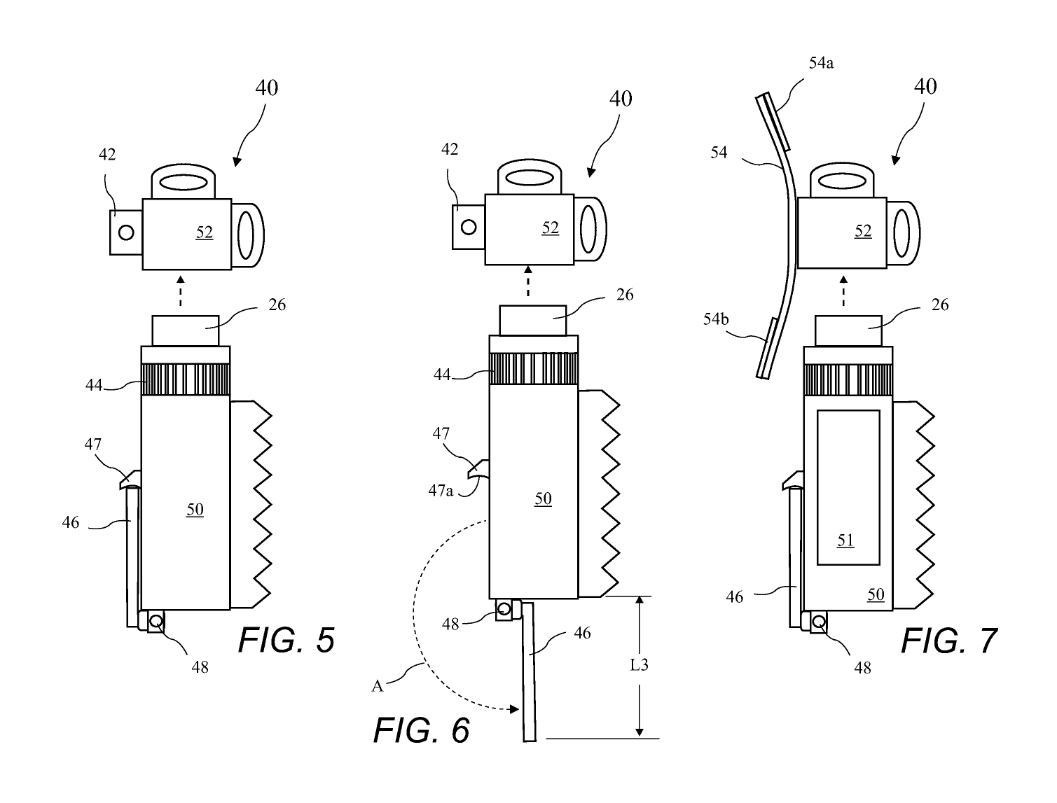

A side view of the surfing accessory 40 with the key 46 folded against the body 50 and the cap 52 removed is shown in FIG. 5 and a side view of the surfing accessory 40 the applicator cap removed and the key 46 folded away from the body 50 for use is shown in FIG. 6. The material 26 is preferably extendable from the body 50 by rotation of the ring 44, but may be extended by other apparatus, for example, a slide reaching through the body 50. The seat 47 has an indent or concave surface 47a for capturing the end of the key 46. When the key 46 is rotated along arc A for use, the body 50 becomes a convenient handle for turning the key 46. The extended key 46 reaches a distance L3 from the body 50 which may vary, but is preferably about 1 and ⅛ inches.

A side view of the surfing accessory 40 with a strap 54 attached to the cap 52 is shown in FIG. 7. The strap 54 may include hook and loop fastening material 54a and 54b, have a buckle, or other features for closing the strap around a convenient wet suit, leash, or other object. The accessory body 50 may further include a reflective surface 51 on a side of the body to allow a surfer to confirm the application of sun screen to their face.

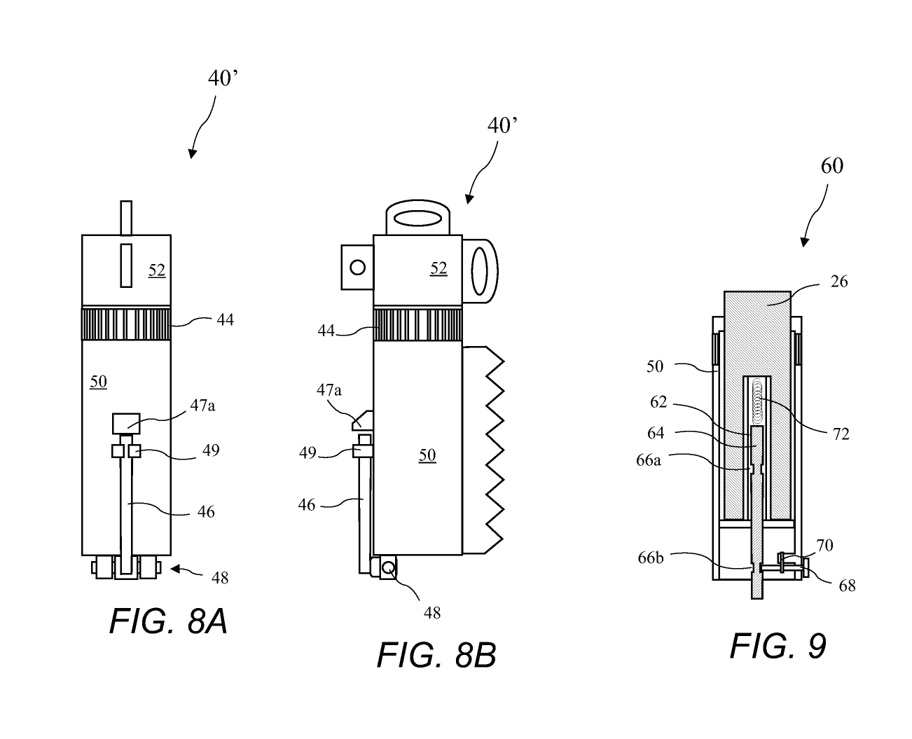

A first side view of a surfing accessory 40′ with a key retainer 49 according to the present invention and a second side view of the surfing accessory 40′ with the key retainer 49 is shown in FIG. 8B. The key retainer 49 is a plastic or rubber like material having a mouth narrower than the cross-section of the key 46 such that the key “snaps” into the key retainer. A second seat 47a does not require a key retaining feature, but remains to prevent snagging the key.

A cross-sectional side view of a surfing accessory 60 with a telescoping key 64 according to the present invention is shown in FIG. 9. The key 64 slides into and out of a cavity 62 in the center of the accessory body 50. The cavity 62 may be in the center of a screw mechanism for extending and retracting the material 26. The key 64 includes two rings or notches 66a and 66b near opposite ends of the key 64. A lock 68 in the base of the body 50 engages the ring 66b to retain the key 64 in the cavity 62 and engaged the ring 66a to retain the key 64 in an extended position. The lock 68 may pivot around a post 70 to engage and disengage the key 64. A spring 72 may reside in the cavity 62 to extend the key 64 when the lock 68 is released.

While the invention herein disclosed has been described by means of specific embodiments and applications thereof, numerous modifications and variations could be made thereto by those skilled in the art without departing from the scope of the invention set forth in the claims.

I claim:

1. A surfing accessory comprising:
a body having an interior, an open end, and a closed end;
a cap attachable to and removable from the open end to seal the interior of the body;
a comb attached to an outer surface of the body extending along the length dimension of the body; and
a fin key attached to the body and having a first unexceeded position and a second extended position for use.

2. The applicator of claim 1, wherein the key is retractable into the accessory body for storing and extendable for use.

3. The applicator of claim 2, wherein the key extends to a position opposite the accessory body for use, the accessory body providing a handle for the key.

4. The applicator of claim 1, wherein the key is filmable against the accessory body for storing and filmable away from the accessory body for use.

5. The applicator of claim 6, wherein the key is filmable to a position opposite the accessory body for use, the accessory body providing a handle for the key.

7. The applicator of claim 1, further including a cord attached to the surfing accessory, the cord detachably attachable to a surfboard leash.

8. The applicator of claim 7, wherein the cord is attached to the cap of the surfing accessory.

9. The applicator of claim 1, further including a tab attached to the surfing accessory, the tab detachably attachable to a surfboard leash.

10. The applicator of claim 9, wherein the tab is attached to the cap of the surfing accessory.

11. The applicator of claim 1, further including a strap attached to the surfing accessory, the strap detachably attachable to a surfboard leash.

12. The applicator of claim 11, wherein the strap is attached to the cap of the surfing accessory.

13. The applicator of claim 1, wherein the accessory body contains sun screen.

14. The applicator of claim 1, wherein the accessory body contains surfboard wax.

15. The applicator of claim 1, wherein the comb is shorter than the length of the accessory body and both ends of the accessory body reach past the length of the comb.

16. The applicator of claim 1, wherein a reflective surface resides on a side of the accessory body to allow a surfer to confirm the application of sun screen to their face.

17. A surfing accessory comprising:
a portion of surfboard wax material;
a cylindrical accessory body for containing the surfboard wax material, the surfboard wax material slidable within the accessory body along a length dimension of the body to expose the surfboard wax material through an open end of the cylindrical accessory body for use by a surfer;
a cap removably attachable to the cylindrical accessory body for covering the open end of the cylindrical accessory body and covering any exposed amount of the surfboard wax material;
a surfboard wax comb attached to an outer surface of the cylindrical accessory body extending along the length dimension of the cylindrical accessory body;
a fin key attached to the cylindrical accessory body, the key foldable against the accessory body for storing and foldable away from the accessory body to a position pointing opposite to the accessory body for use, the accessory body providing a handle for the key; and
an attachment feature attached to the surfing accessory cap for securing the surfboard accessory while surfing.

18. A surfing accessory comprising:
a portion of sun screen material;
a cylindrical accessory body for containing the sun screen material, the sun screen material slidable within the accessory body along a length dimension of the body to expose the sun screen material through an open end of the cylindrical accessory body for use by a surfer;
a cap removably attachable to the cylindrical accessory body for covering the open end of the cylindrical accessory body and covering any exposed amount of the sun screen material;
a surfboard wax comb attached to an outer surface of the cylindrical accessory body extending along the length dimension of the cylindrical accessory body;
a fin key attached to the cylindrical accessory body, the key foldable against the accessory body for storing and foldable away from the accessory body to a position pointing opposite to the accessory body for use, the accessory body providing a handle for the key; and
an attachment feature attached to the surfing accessory cap for securing the surfboard accessory while surfing.
